(19) United States
(12) Patent Application Publication
(10) Pub. No.: US 2026/0355707 A1
(43) Pub. Date: Nov. 12, 2026

(54) MODULAR LABORATORY DEVICE

(71) Applicant: Hans Heidolph Gmbh, Kelheim (DE)

(72) Inventor: Andrej JARRESCH, Schwabach (DE)

(73) Assignee: Hans Heidolph Gmbh, Kelheim (DE)

(21) Appl. No.: 19/122,454

(22) PCT Filed: Oct. 3, 2023
(86) PCT No.: PCT/EP2023/077322

§ 371 Date: Apr. 18, 2025

(30) Foreign Application Priority Data
Oct. 19, 2022 (DE) 20 2022 105 879.2

(51) Int. Cl. B01F 31/20; B01F 31/22; B01F 31/23; B01F 31/24; B01F 101/23

(52) U.S. Cl. CPC B01F 31/26; B01F 31/22; B01F 31/23; B01F 31/24; B01F 2101/23

(57) ABSTRACT

A modular laboratory device includes a sample receiving element, which is designed to receive a sample, a drive, and at least one transfer element, which has a central axis and is designed to be driven by the drive to perform a rotational movement about the central axis and to transmit this rotational movement to the sample receiving element in such a way that it executes a defined movement sequence. The laboratory device includes at least one first transfer element and one second transfer element, which are optionally and replaceably insertable into the laboratory device, and which differ in that the sample receiving element executes different movement sequences. The laboratory device may include at least one third transfer element that defines different attachment positions for the sample receiving element, which differ in that the sample receiving element executes different movement sequences.

The present invention relates to a modular laboratory device, in particular a shaking and/or mixing device for shaking and/or mixing substances.

Laboratory devices are designed for being employed in a laboratory and serve in particular to treat one or more substances or samples. In particular, the laboratory device may be designed to mix and/or shake one or more substances by means of targeted and preferentially periodic movements and thereby increase the degree of homogenization of the substance(s).

For this purpose, the laboratory device may be designed to execute different movement sequences. For example, a laboratory device may execute one of the following movements:
an oscillating movement along an axis of movement, also referred to as a reciprocal movement,
a circular or oval oscillating movement in a plane, also referred to as an orbital movement or vibrational movement,
a rocking movement, during which the substance(s) are alternately tilted in opposite directions about an axis,
a wobbling movement, during which the substance(s) execute a rotating tilting movement about a central point.

Depending on the number of desired movement forms or sequences, it may be required to have a plurality of distinct laboratory devices on hand to then be able to select the respective laboratory device that executes the desired movement sequence.

It is an object of the present invention to provide an alternative or improved laboratory device which, in particular providing the smallest possible number of components, allows the largest possible selection of distinct movement sequences, in particular movement sequences that serve to thoroughly mix a sample.

This object is attained by a laboratory device according to claim 1, a laboratory device according to claim 18, and a method according to claim 21. Developments of the laboratory devices are each given in the dependent claims and in the embodiments below. The features of the laboratory devices may also be utilized for developments among each other, and the method may also be developed by features of the laboratory device and vice versa.

A modular laboratory device according to the invention comprises a sample receiving element, which is designed to receive a sample, a drive, and at least one transfer element, which has a central axis and is designed to be driven by the drive to perform a rotational movement about the central axis and to transmit this rotational movement to the sample receiving element in such a way that it executes a defined movement sequence. The laboratory device comprises at least one first transfer element and one second transfer element, wherein the first and the second transfer elements are selectively and replaceably insertable into the laboratory device, and the first transfer element is designed to transmit the rotational movement to the sample receiving element in such a way that the sample receiving element executes a first movement sequence, and the second transfer element is designed to transmit the rotational movement to the sample receiving element in such a way that the sample receiving element executes a second movement sequence, which differs from the first movement sequence. Alternatively or additionally, the laboratory device comprises at least one third transfer element, which is designed in such a way that the sample receiving element is attachable to the third transfer element at a first attachment position and at a second attachment position distinct from the first attachment position, and to transmit the rotational movement to the sample receiving element at the first attachment position in such a way that the sample receiving element executes a third movement sequence, and to transmit it to the sample receiving element at the second attachment position in such a way that the sample receiving element executes a fourth movement sequence, which differs from the third movement sequence.

In particular, the laboratory device may serve to thoroughly mix a sample. Preferentially, the laboratory device is a shaking and/or mixing device.

The transfer element may, for example, comprise an output shaft, which defines the central axis and is designed to be driven by the drive to perform a rotational movement about the central axis, as well as a fastening element for attaching the sample receiving element to the output shaft at an attachment position defined by the fastening element. Further, the transfer element may comprise, for example, a frame element, which prevents rotational movement of the sample receiving element about a center axis of the sample receiving element and/or to which the sample receiving element is attachable at a further attachment position.

An attachment position of the sample receiving element may in particular be a position defined with respect to the central axis, preferentially defined by a distance of a center point of the sample receiving element from the central axis, wherein the distance may also be zero, and/or by an angle at which a center axis of the sample receiving element intersects the central axis. Alternatively or additionally, an attachment position of the sample receiving element may be defined by which constituent of the transfer element (e.g., the output shaft mentioned above or the frame element) the sample receiving element is attached to.

Exchangeability of the transfer element does not necessarily mean that all constituents of the transfer element are exchanged. For example, the output shaft mentioned above may be left in place, and only a different frame element may be inserted into the laboratory device, or only a different output shaft may be inserted into the laboratory device while using the same frame element, etc. Typically, however, the aforementioned components of the transfer element are adapted to each other so that, e.g., both the output shaft and the frame element are replaced to enable a different movement sequence.

A movement sequence transmitted to the sample receiving element refers in particular to a, in particular periodically, recurring sequence of one or more movements which are imparted to the sample receiving element to thoroughly mix a sample provided at or on the sample receiving element.

The modular laboratory device described above makes it possible, for example, to enable a plurality of distinct movement sequences with the same laboratory device using as few distinct components as possible. Thereby, the employment area of the laboratory device may be increased, for example.

Preferentially, the first and second movement sequences and/or the third and fourth movement sequences are each one from the following group of movement sequences:
a movement exclusively in a plane perpendicular to the central axis,
a movement having exclusively movement components parallel to the central axis,
a movement having both movement components parallel to the central axis and movement components perpendicular to the central axis,
and are preferentially each one of the following group of movement sequences:
an oscillating movement in exclusively one direction perpendicular to the central axis,
a circular or oval oscillating movement in a plane perpendicular to the central axis with a first radius or a second radius distinct from the first radius,
a rocking movement, during which the sample receiving element is tilted alternately in opposite directions about an axis, preferentially an axis perpendicular to the central axis,
a wobbling movement, during which the sample receiving element executes a rotating tilting movement about a central point, preferentially a central point on the central axis.

Each of these movements preferentially serves to thoroughly mix the sample by means of the laboratory device and is prespecified, in particular regarding its movement sequence. An oscillating movement is in particular understood to mean a periodic and uniform movement. For example, it may be a reciprocal movement along a direction. A circular or oval oscillating movement in a plane perpendicular to the central axis may also be referred to as an orbital or vibrational movement, in particular depending on a radius of movement. During a wobbling movement, an axis of the sample receiving element, in particular a center axis mentioned below, is preferentially pivoted relative to the central axis, wherein the radial alignment of the pivoting rotates periodically about the central axis.

By means of the movement sequences described above, for example, distinct types of through mixing of a sample using the laboratory device may be realized, from which a suitable type of thorough mixing may be selected, in particular depending on properties, e.g., physical and/or chemical properties, of the sample.

Preferentially, the first and the second transfer elements differ in an attachment position of the sample receiving element to the respective transfer element. Thereby, a desired movement sequence may be selected from a plurality of movement sequences in a simple manner.

Preferentially, the modular laboratory device further comprises a fastening element, which is designed to attach the sample receiving element to the respective transfer element at the respective attachment position, wherein the fastening element has a center axis, which defines the attachment position, and wherein the respective attachment position is defined by one of the following features:
the center axis of the fastening element is provided so as to be parallel to the central axis and offset therefrom, in particular by a first distance or a second distance not equal to the first distance;
the center axis of the fastening element intersects the central axis at an angle greater than 0° and less than 90°, preferentially at an angle between 2° and 10°, in particular 5°.

More preferably, a plane of the sample receiving element, in particular a plane of a carrier surface of the sample receiving element, is provided so as to be perpendicular to the center axis of the fastening element.

The fastening element may, for example, comprise a screw or a pin, which is introducible into a bore of the transfer element, in particular a bore of an output shaft mentioned above, to attach the sample receiving element to the output shaft. The bore or pin or screw may in particular have a longitudinal extension, which defines the center axis. Alternatively or additionally, the fastening element may, for example, have an output flange, which defines the center axis and to which the sample receiving element is attachable. In particular, the output flange may be attached to an aforementioned output shaft and be rotatably mounted with respect to the output shaft to prevent rotation of the sample receiving element. An output flange may also be a constituent of the respective transfer element, and/or the fastening element may be a constituent of the transfer element.

Preferentially, the center axis of the fastening element also passes through a center point of the sample receiving element, and more preferably forms a center axis of the sample receiving element. Alternatively or additionally, it is preferable that a plane of the sample receiving element, in particular a plane of a carrier surface of the sample receiving element, is provided so as to be perpendicular to the center axis of the fastening element.

By arranging the center axis so as to be offset from the central axis, for example, an eccentric movement may be generated to the sample receiving element in a plane, in particular in a plane perpendicular to the central axis. By arranging the center axis at an angle to the central axis, for example, a movement may be transmitted to the sample receiving element, which not only has movement components perpendicular to the central axis but also parallel to the central axis.

Attaching the sample receiving element at one of the attachment positions described above may, for example, enable a movement sequence of the sample receiving element caused by the attachment position to be chosen in a simple manner.

Preferentially, the respective transfer element is designed to maintain a spatial orientation of the sample receiving element with respect to the center axis of the fastening element, in particular to prevent rotation of the sample receiving element about the center axis of the fastening element.

Rotation of the sample receiving element about the center axis may be prevented, for example, by providing an output flange as described below, wherein the sample receiving element is fastened to the output flange, and the output flange is provided so as to be rotatably mounted on the output shaft. Alternatively or additionally, the rotation of the sample receiving element about the center axis may also be prevented, for example, by providing a frame element as described below. In particular, the frame element may be attached to the output flange.

By preventing rotation of the sample receiving element about the center axis, it is possible, for example, to achieve improved thorough mixing of a sample arranged on the sample receiving element.

Preferentially, the respective transfer element comprises an output shaft, which extends across the central axis from an upper end to a lower end and which is designed to be driven by the drive to perform a rotational movement about the central axis, wherein the fastening element comprises a bore provided in the output shaft, which extends from the upper end towards the center axis, in particular towards the lower end parallel to the center axis, and/or wherein the output shaft comprises a contact surface at the upper end for attaching the sample receiving element, and the contact surface extends perpendicularly to the center axis of the fastening element.

For example, the center axis may be defined by an axis of the bore, and simultaneously, the bore may serve to attach the sample receiving element to the output shaft so that an attachment position of the sample receiving element is defined by the center axis. Alternatively or additionally, an attachment position of the sample receiving element may be defined by the contact surface.

Preferentially, the respective transfer element comprises a frame element, which is designed to prevent rotation of the sample receiving element about the center axis. Alternatively or additionally, the frame element may serve to define an attachment position of the sample receiving element. The frame element may in particular be connected to a drive flange of the laboratory device, which is fastened to an output shaft as described above and rotatably mounted relative thereto, and to which the sample receiving element is attachable at an attachment position. Thereby, for example, a movement may be imparted to the frame element on the one hand, and the rotation of the sample receiving element about the center axis may be prevented on the other hand, which may lead to improved thorough mixing of the sample.

Preferentially, the frame element comprises at least one elastic element, in particular a spring element, preferentially a leaf spring, and is designed to allow a movement of the sample receiving element in a plane perpendicular to the central axis, in particular a circular or oval oscillating movement in a plane perpendicular to the central axis, and preferentially to allow a movement exclusively in this plane.

More preferably, the frame element comprises four elastic elements. The frame element is also referred to as a spring frame or leaf spring frame. It is preferentially used together with a configuration of the transfer element or of the fastening element described above, in which a center axis of the fastening element and/or of the sample receiving element is provided so as to be parallel to the central axis and offset therefrom.

This, for example, makes an orbital or vibrational movement of the sample receiving element realizable in a simple manner.

Alternatively or additionally, a frame element is preferentially provided, which comprises a frame which is attached to the laboratory device so as to be pivotable about a first axis, and wherein the sample receiving element is attachable to the frame so as to be pivotable about a second axis, wherein the first axis and the second axis intersect the central axis at a central point. Preferentially, the transfer element comprises an output shaft, which is designed to be driven by the drive to perform a rotational movement about the central axis, and an output flange, which has, along the center axis of the fastening element, which intersects the central axis at an angle greater than 0° and less than 90°, more preferably at an angle between 2° and 10°, in particular 5°, an upper portion and a lower portion, wherein the lower portion is attached to the output shaft and the upper portion defines a first attachment position of the sample receiving element, at which the sample receiving element is attached to the upper portion, and wherein the frame element defines a second attachment position of the sample receiving element, at which the sample receiving element is attached to the frame element. Yet more preferably, the transfer element is designed in such a way that the sample receiving element, during operation of the laboratory device, executes a wobbling movement about the central point if it is at the first attachment position, and executes a rocking movement about the first axis if it is at the second attachment position.

The frame element described herein is also referred to as a rocking frame. It is preferentially used together with a configuration of the transfer element or of the fastening element described above, in which a center axis of the fastening element and/or of the sample receiving element intersects the central axis at an angle greater than 0° and less than 90°, wherein the intersection point of the center axis with the central axis is the central point.

The frame element makes it possible, for example, to choose between a wobbling movement and a rocking movement of the sample receiving element in a simple manner.

Alternatively or additionally, the transfer element of the modular laboratory device comprises an output shaft, which extends along the central axis from an upper end to a lower end and which is designed to be driven by the drive to perform a rotational movement about the central axis, and the transfer element further comprises a frame element, which is designed to transmit the movement of the output shaft about the central axis to the sample receiving element in such a way that the sample receiving element executes a movement exclusively in a plane perpendicular to the central axis, in particular an oscillating movement in exclusively one direction perpendicular to the central axis. More preferably, the frame element has a carriage and a guide element extending along a first axis, on which the carriage is provided so as to be displaceable, and wherein the carriage has a recess designed so as to be elongated, whose longitudinal axis extends transversely, preferentially perpendicularly, to the first axis, and wherein more preferably, the output shaft, at its upper end, has a transfer portion, which defines a center axis, which is provided so as to be parallel to the central axis and offset therefrom by a distance, and the recess of the carriage is designed to receive the transfer portion so that the transfer portion is provided in the recess so as to be movable along its longitudinal axis. Alternatively or additionally, it is more preferable that the sample receiving element is attachable to the carriage. The first axis of the guide element preferentially corresponds to the direction perpendicular to the central axis, in which the oscillating movement is imparted to the sample receiving element.

The frame element described herein is also referred to as a reciprocal frame. Preferentially, an eccentric movement of the transfer portion is caused by the rotation of the output shaft about the central axis and by the spacing of the center axis of the transfer portion from the central axis. By configuring the frame element in the form of a carriage displaceable along an axis with an elongated recess transversely or perpendicularly to this axis, the eccentric movement of the transfer portion may be transmitted, for example, to a linear oscillating movement, also referred to as a linear reciprocal movement, of the sample receiving element, i.e., a back-and-forth movement on an axis of movement, in particular on the first axis of the guide element.

The center axis of the transfer portion may, for example, simultaneously or alternatively be a center axis as described above, i.e., a center axis defined by a fastening element which defines an attachment position of the sample receiving element to the output shaft and/or an output flange.

Preferentially, the frame element is designed to prevent rotation of the sample receiving element about the center axis and in particular to maintain a spatial orientation of the sample receiving element with respect to the center axis, and/or a plane of the sample receiving element, in particular a plane of a carrier surface of the sample receiving element, is provided so as to be perpendicular to the center axis.

The frame element described above makes it possible, for example, to realize a reciprocal movement of the sample receiving element in a simple manner.

Preferentially, the modular laboratory device comprises a base plate, on which the drive is arranged, and a bearing unit, which is attached to the base plate and which is designed in such a way that the respective transfer element is insertable into the bearing unit in such a way that the transfer element is held in the bearing unit so as to be rotatable about the central axis and the central axis is preferentially arranged vertically and/or perpendicularly to a plane of the base plate, and the respective transfer element is removable from the bearing unit. More preferably, the base plate, the drive and the bearing unit form a base unit to which the respective transfer element is selectively attachable, and/or the drive is provided so as to be offset from the central axis and connected to the bearing unit via a belt.

For example, providing the base unit may make it easier for the user to use the laboratory device. For example, by arranging the drive so as to be offset from the central axis, the laboratory device may be designed to be more compact.

Preferentially, the sample receiving element is designed as a carrier plate. Preferentially, the carrier plate is designed so as to be circular, wherein the center axis described above passes through the center of the circle when the carrier plate is attached to the laboratory device. Preferentially, the carrier plate has fastening elements, for example in the form of screws and/or recesses interacting with screws and/or magnets, which allow the carrier plate to be attached at any attachment position realizable with the laboratory device.

According to the invention, a frame element is provided for a laboratory device, in particular for a shaking and/or mixing device, which comprises a sample receiving element for receiving a sample and a drive. The frame element comprises a frame and a bracket for attaching the frame element to the laboratory device, wherein the frame is connected to the bracket so as to be pivotable about a first axis, and the frame is designed to receive the sample receiving element in such a way that the sample receiving element is provided on the frame so as to be pivotable about a second axis, wherein the first axis and the second axis intersect at a central point. Preferentially, the laboratory device comprises an output shaft, which is designed to be driven by the drive to perform a rotational movement about a central axis, and an output flange, which has, along a center axis, which intersects the central axis at an angle greater than 0° and less than 90°, an upper portion and a lower portion, wherein the lower portion is attached to the output shaft and the upper portion defines a first attachment position of the sample receiving element, at which the sample receiving element is attached to the upper portion, and the frame element defines a second attachment position of the sample receiving element, at which the sample receiving element is attached to the frame element. More preferably, the frame element is designed to prevent rotation of the sample receiving element about the center axis of the output flange, and/or the laboratory device is designed in such a way that the sample receiving element, during operation of the laboratory device, executes a wobbling movement about the central point if it is at the first attachment position, and/or the frame element is designed in such a way that the sample receiving element, during operation of the laboratory device, executes a rocking movement about the first axis if it is at the second attachment position. More preferably, a laboratory device, in particular a shaking and/or mixing device, is provided, which comprises the frame element described above.

The frame element may in particular be a rocking frame as described above and/or be developed by the above-stated features of the rocking frame. The frame element makes it possible, for example, to choose between a wobbling movement and a rocking movement of the sample receiving element in a simple manner, thus increasing the modularity of a laboratory device with which the frame element is used.

According to a further aspect, a method for using a modular laboratory device, in particular a shaking and/or mixing device, is provided, wherein the laboratory device comprises a sample receiving element, which is designed to receive a sample, a drive, and at least one transfer element, which has a central axis and is designed to be driven by the drive to perform a rotational movement about the central axis and to transmit this rotational movement to the sample receiving element in such a way that it executes a defined movement sequence. The method comprises selecting a transfer element from at least one first transfer element and one second transfer element, wherein the first and the second transfer elements are selectively and replaceably insertable into the laboratory device, and the first transfer element is designed to transmit the rotational movement to the sample receiving element in such a way that the sample receiving element executes a first movement sequence, and the second transfer element is designed to transmit the rotational movement to the sample receiving element in such a way that the sample receiving element executes a second movement sequence, which differs from the first movement sequence, as well as inserting the selected transfer element into the laboratory device. Alternatively or additionally, the method comprises selecting an attachment position from at least one first attachment position and one second attachment position distinct from the first attachment position, wherein the laboratory device comprises at least one third transfer element, which is designed in such a way that the sample receiving element is attachable to the third transfer element at the first attachment position and at the second attachment position, and to transmit the rotational movement to the sample receiving element at the first attachment position in such a way that the sample receiving element executes a third movement sequence, and to transmit it to the sample receiving element at the second attachment position in such a way that the sample receiving element executes a fourth movement sequence, which differs from the third movement sequence, as well as attaching the sample receiving element at the selected attachment position. The method may be developed by features of the modular laboratory device according to the invention and/or by features of the frame element according to the invention.

Further features and conveniences of the invention will result from the description of exemplary embodiments with reference to the accompanying drawings.

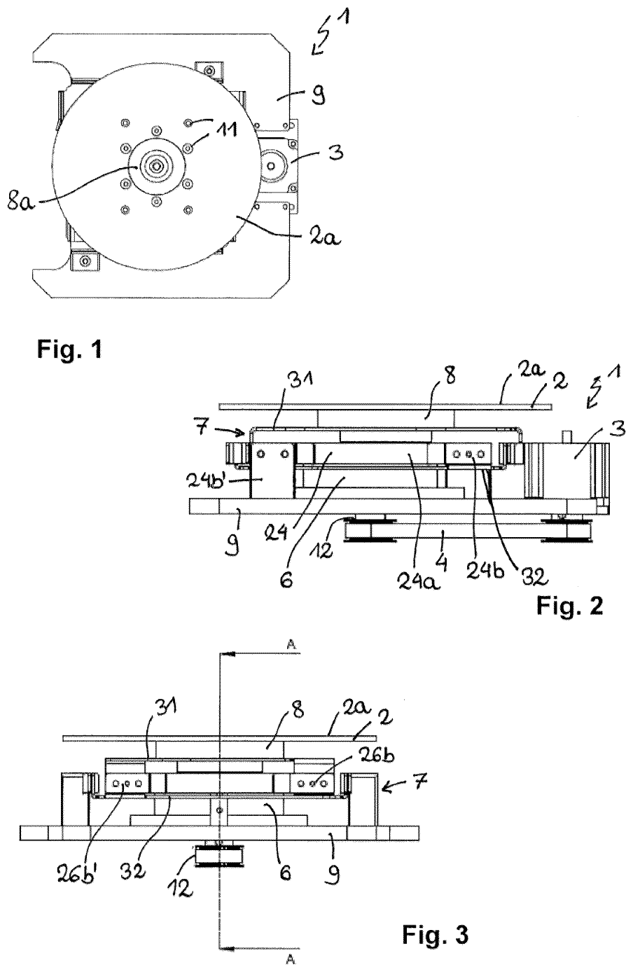

FIG. 1 shows a schematic top view of a laboratory device according to a first embodiment of the invention;

FIG. 2 shows a schematic side view of the laboratory device in FIG. 1;

FIG. 3 shows a schematic front view of the laboratory device in FIGS. 1, 2;

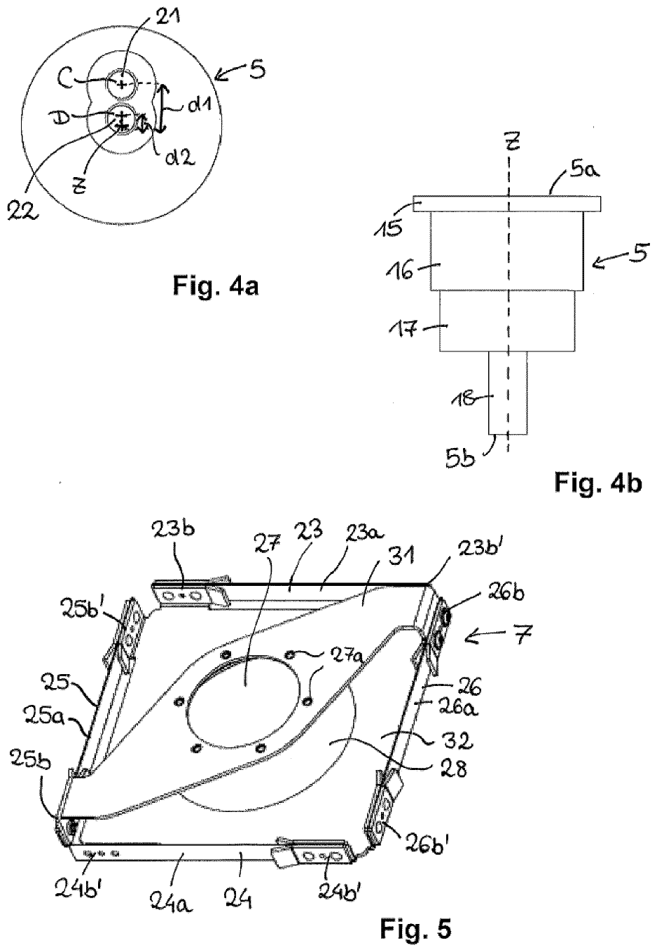

FIGS. 4a and 4b show an output shaft of the laboratory device shown in FIGS. 1 to 3, wherein FIG. 4a represents a schematic top view of the output shaft, and FIG. 4b represents a schematic side view of the output shaft;

FIG. 5 shows a schematic perspective view of a frame element of the laboratory device shown in FIGS. 1 to 3;

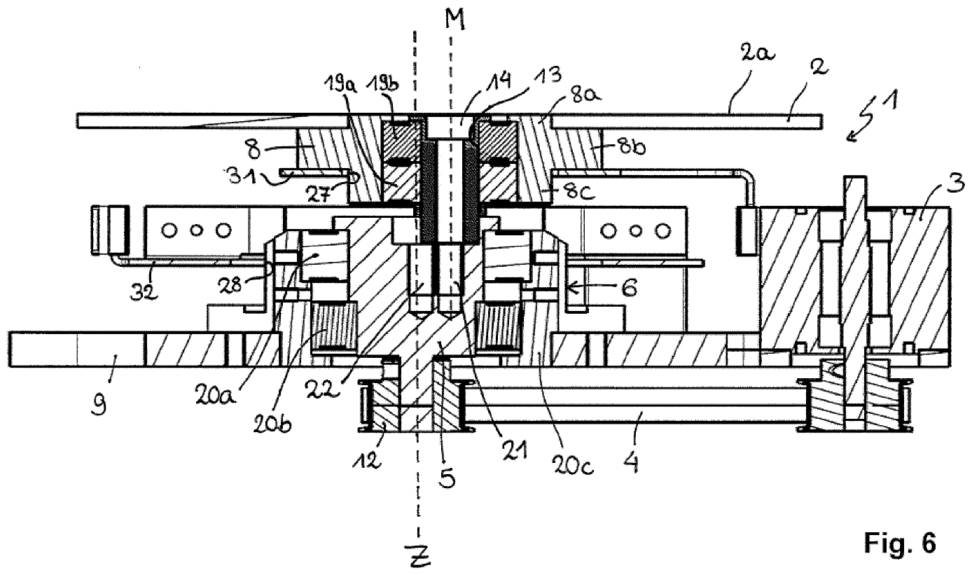

FIG. 6 shows a schematic cross-sectional view of the laboratory device shown in FIGS. 1 to 3 along the line A-A in FIG. 3;

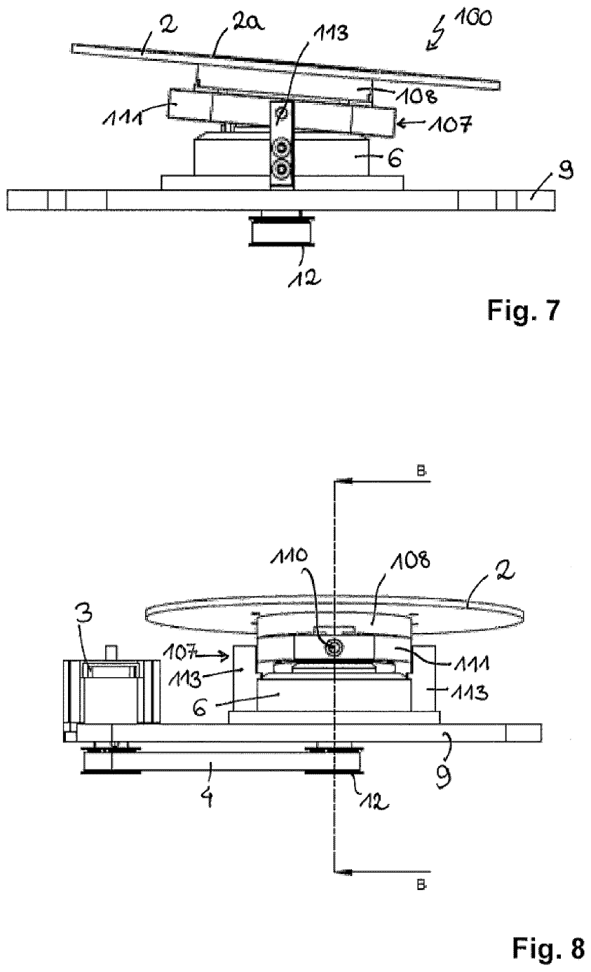

FIG. 7 shows a schematic front view of a laboratory device according to a second embodiment of the invention;

FIG. 8 shows a schematic perspective side view of the laboratory device in FIG. 7;

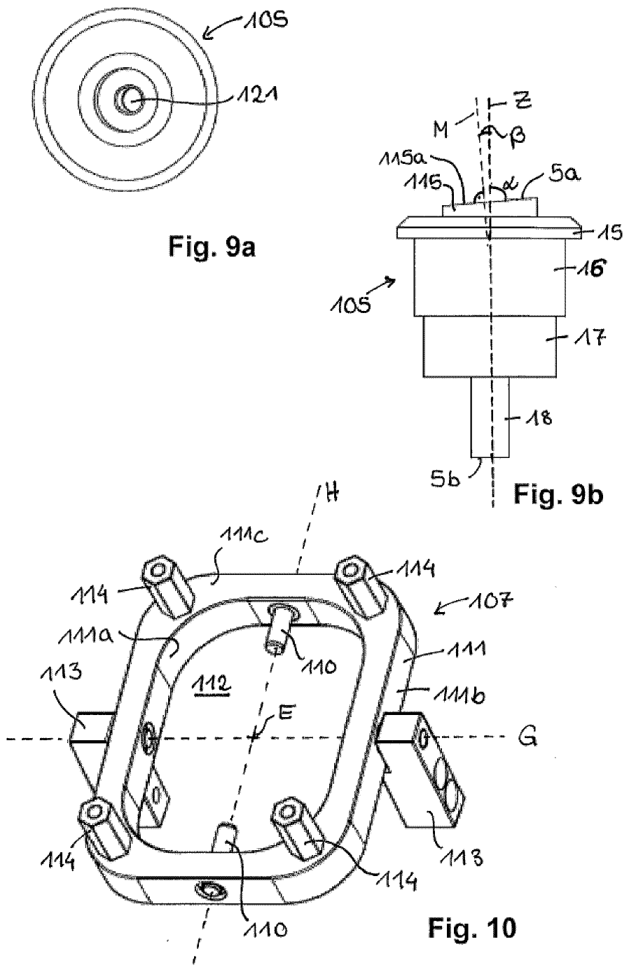

FIGS. 9a and 9b show an output shaft of the laboratory device shown in FIGS. 7 and 8, wherein FIG. 9a represents a schematic top view of the output shaft, and FIG. 9b represents a schematic side view of the output shaft;

FIG. 10 shows a schematic perspective view of a frame element of the laboratory device shown in FIGS. 7 and 8;

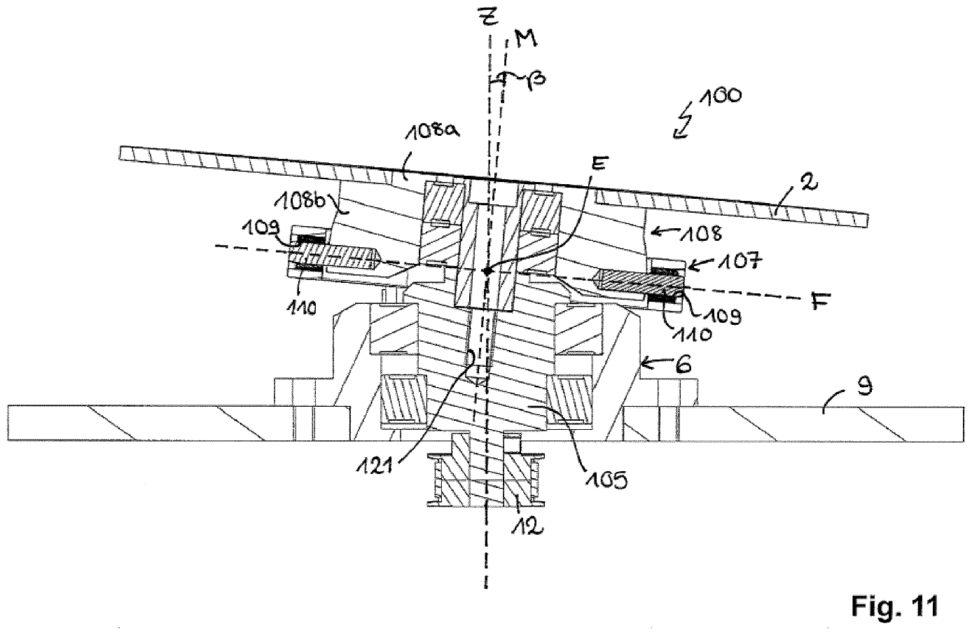

FIG. 11 shows a schematic cross-sectional view of the laboratory device shown in FIGS. 7 and 8 along the line B-B in FIG. 8;

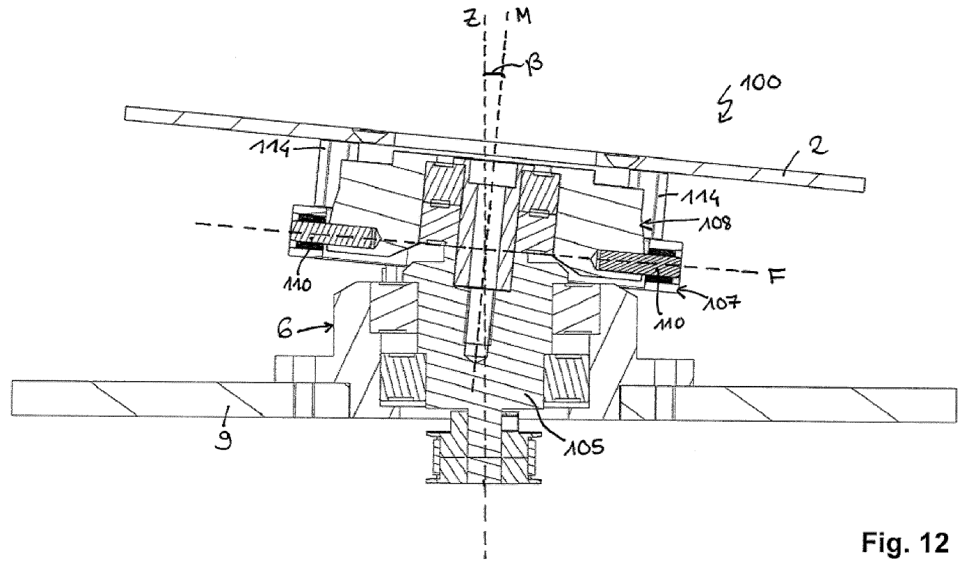

FIG. 12 shows a schematic cross-sectional view of a development of the laboratory device shown in FIGS. 7 to 11;

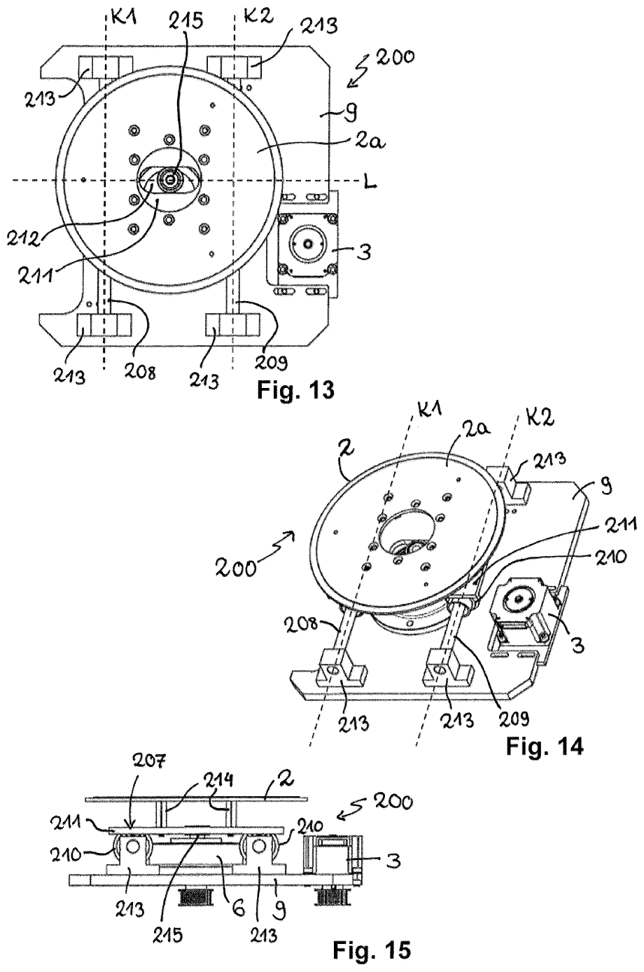

FIG. 13 shows a schematic top view of a laboratory device according to a third embodiment of the invention;

FIG. 14 shows a schematic perspective view of the laboratory device shown in FIG. 13;

FIG. 15 shows a schematic side view of the laboratory device in FIGS. 13, 14;

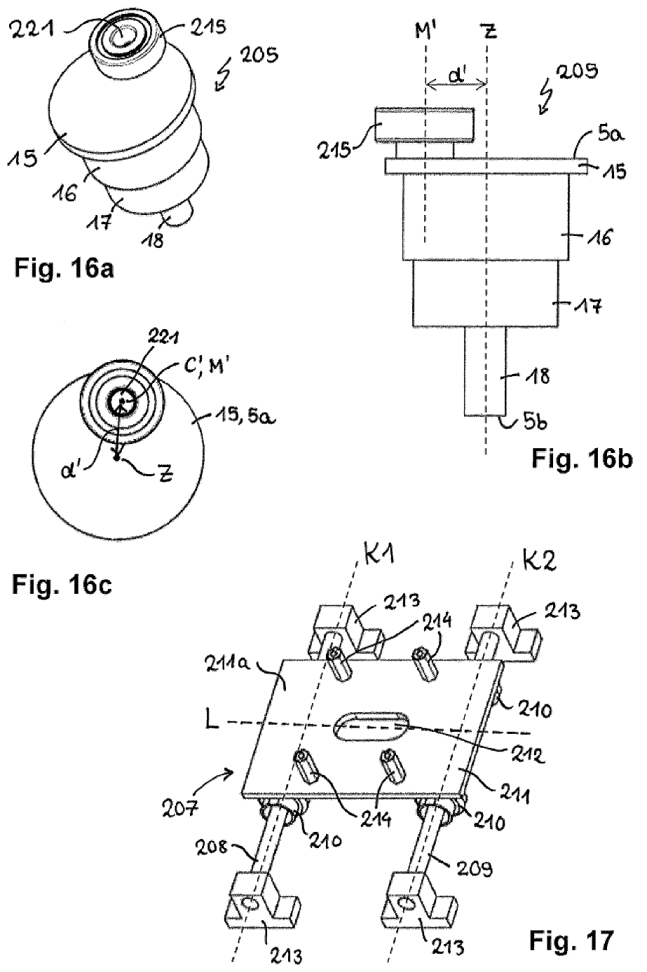

FIGS. 16a-c show an output shaft of the laboratory device shown in FIGS. 13 to 15, wherein FIG. 16a represents a schematic perspective view of the output shaft, FIG. 16b represents a schematic side view of the output shaft, and FIG. 16c represents a schematic top view of the output shaft; and

FIG. 17 shows a schematic perspective view of a frame element of the laboratory device shown in FIGS. 13 to 15.

In the following, a first embodiment of a laboratory device according to the invention will be described with reference to FIGS. 1 to 6. The laboratory device is designed as a shaking and/or mixing device 1. For receiving one or more substance(s) or sample(s) not shown in the Figures, which is/are provided in particular in a container (also not shown), the shaking and/or mixing device 1 has a sample receiving element in the form of a carrier plate 2.

As best seen in FIGS. 1 to 3 and 6, the shaking and/or mixing device 1 further comprises a drive 3, a belt 4, an output shaft 5 (see FIG. 6), a bearing unit 6, a frame element 7, an output flange 8, and a base plate 9. The drive 3 is connected to the output shaft 5 via the belt 4 to impart a rotational movement about a central axis Z to the output shaft 5. The output shaft 5 is held in the bearing unit 6 so as to be rotatable about the central axis Z. The output flange 8 is attached to an upper end of the output shaft 5 and connected to the frame element 7. In the present embodiment, the carrier plate 2 is attached to the output flange 8.

Preferentially, the drive 3 and the bearing unit 6 are attached to the base plate 9, in particular firmly connected thereto, and form, together with the carrier plate 2, a base unit of the shaking and/or mixing device 1. The output flange 8, the output shaft 5 and the frame element 7 are preferentially provided on or in the base unit so as to be exchangeable.

The carrier plate 2 comprises a top side facing upwards, i.e., facing away from the base plate 9, which forms a carrier surface 2a on which the sample (not shown in the Figures) is arrangeable. The carrier plate 2 has fastening elements 11 (see FIG. 1), for example screws and/or recesses for screws and/or magnets, to fasten the carrier plate 2 to the output flange 8 and/or the frame element. The fastening elements 11 are designed as detachable fastening elements. Thus, the carrier plate 2 can be attached to the laboratory device and detached or removed therefrom. The carrier plate 2 may have a bracket not shown in the Figures or a rim designed so as to be raised to prevent the sample arranged thereon from falling off. In the Figures, the carrier plate 2 is represented as a circular plate, however, it may also have a shape deviating from a circular shape.

The drive 3 may, for example, be a rotary drive, preferentially it is designed as a stepper motor. In the Figures, the drive 3 is provided so as to be offset horizontally from the central axis Z of the output shaft 5. Alternatively, the drive 3 may also be attached to the base plate 9 below the output shaft 5 to transmit a drive force applied by the drive 3 directly, i.e., in particular without the belt 4, to the output shaft 5.

The bearing unit 6 is designed to receive the output shaft 5, e.g., in a central recess of the bearing unit, in such a way that the output shaft 5 is held at an intended operating position. In particular, the intended operating position may be defined in such a way that the central axis Z of the output shaft 5 is arranged so as to be substantially perpendicular to a plane of the base plate 9 and/or in a vertical direction. Further, the bearing unit 6 is designed in such a way that the output shaft 5 is rotatable about its central axis Z if it is inserted into the bearing unit 6. For this, the bearing unit may, for example, have one or more bearings 20a, 20b, e.g., deep-groove ball bearings, which are provided in a housing 20c of the bearing unit (see FIG. 6).

As shown in FIG. 6, in the present embodiment, the output flange 8 is designed so as to be substantially cylindrical with a center axis M (cylinder axis). It has, along the center axis M from an upper end to a lower end of the output flange, successively, a first cylinder portion 8a, a second cylinder portion 8b, and a third cylinder portion 8c (see FIG. 6). A diameter of the second cylinder portion 8b is greater than respective diameters of the first and third cylinder portions 8a, 8c. The first cylinder portion 8a is designed in such a way that it extends through a central recess of the carrier plate 2 (see also FIG. 1) so that the carrier plate 2 rests on a protrusion formed by the second cylinder portion 8b and is fastenable thereto. The third cylinder portion 8c is designed to be received in the frame element 7.

A central recess 13 extends through the output flange 8 from its upper end to its lower end along the center axis M, into which recess a fastening element 14, for example a pin or a screw, is introducible for attaching the output flange 8 to a bore 21, 22 (see also FIG. 4a) of the output shaft 5, as shown in FIG. 6. The center axis M of the output flange 8 extends through a center point of the carrier plate 2 or the carrier surface 2a and runs perpendicularly to the plane of the carrier surface 2a if the carrier plate 2 is fastened to the output flange 8 (see FIG. 6). One or more bearings, in FIG. 6 two bearings 19a, 19b, are provided arranged radially around the central recess 13 of the output flange 8, which allow a rotational movement of the output shaft 5 relative to the output flange 8. In an axial direction (i.e., along the axes Z, M), the output flange 8 is held against the output shaft 5 by the fastening element 14.

The output shaft 5 will be described in more detail in the following with additional reference to FIGS. 4a and 4b. The output shaft 5 extends along its central axis Z from an upper end 5a to a lower end 5b. From the upper end 5a to the lower end 5b, it has various portions 15, 16, 17 and 18 in succession, each of which is designed so as to be substantially cylindrical with the central axis Z as the respective cylinder axis. In the present exemplary embodiment, the portions 15-18 have different diameters perpendicular to the central axis Z, wherein the diameters of the individual portions 15-18 decrease from the portion 15 provided at the upper end 5a to the portion 18 provided at the lower end 5b. Thus, the output shaft 5 is introducible into the bearing unit 6 from above (see FIG. 6). Preferentially, the portion 15 provided at the upper end 5a forms a protrusion, which forms a stop for the output shaft 5 in the bearing unit 6 and thus defines an end position of the output shaft 5 in the bearing unit 6 towards the central axis Z.

The middle portions 16 and 17 of the output shaft 5 may, for example, be provided at positions of respective bearings 20a, 20b (see FIG. 6) of the bearing unit 6 if the output shaft 5 is inserted into the bearing unit 6. The portion 18 provided at the lower end 5b of the output shaft 5 is connected to the belt 4 via a further, rotatably mounted flange 12 to impart a rotational movement about the central axis Z to the output shaft 5 during operation of the drive 3.

Further, in the present embodiment, the output shaft 5 has two bores 21, 22, which each extend from the upper end 5a parallel to the central axis Z towards the lower end 5b of the output shaft 5 (see FIG. 4a and FIG. 6). The bores 21, 22 are each designed to receive a portion of the fastening element 14 therein, which serves to attach the output flange 8 to the output shaft 5. The fastening element 14 is optionally attachable to the bore 21 or to the bore 22, i.e., the bores define different attachment positions of the carrier plate 2. Each of the bores 21, 22 extends parallel to the central axis Z, however, is not provided so as to be concentric with the output shaft 5, i.e., respective center points C and D, through which the center axis M of the output flange 8 extends when it is attached to the output shaft in the respective bore 21, 22, are provided so as to be offset from the central axis Z, as shown in FIGS. 4a and 6. In FIG. 4a, the center point C of the bore 21 is spaced by a first distance d1, and the center point D of the bore 22 is spaced by a second distance d2 from the central axis Z, wherein d1>d2. Thereby, a rotational movement of the output shaft 5 about its central axis Z is transmitted eccentrically to the output flange 8 and to the carrier plate 2 so that they execute a circular or oval oscillating movement (orbital or vibrational movement) in a plane perpendicular to the central axis Z, preferentially in a horizontal plane. A radius of movement of the orbital or vibrational movement is adjustable by selectively choosing one of the two bores 21, 22, i.e., the respective attachment position.

When the output flange 8 is attached to the output shaft 5 by means of the fastening element 14, a gap may be provided between the output flange 8 and the output shaft 5, as shown in FIG. 6. Alternatively, the output flange 8 may also contact the output shaft 5 or be seated thereon so that a surface of the output shaft 5 forms a contact surface for the output flange 8 at its upper end 5a (not shown in the Figures). This contact surface may also serve to attach the output flange 8 to the output shaft 5.

In the following, the frame element 7 will be described in more detail with reference to FIG. 5. The frame element 7 has a top surface 31, a bottom surface 32 and four spring elements 23, 24, 25 and 26 connecting the top and bottom surfaces and arranged substantially in a rectangular, in particular square, frame shape. The frame element 7 of the present embodiment is therefore also referred to as a leaf spring frame. When the frame element 7 is attached to the laboratory device 1, the top surface 31 and the bottom surface 32 are provided so as to be substantially perpendicular to the central axis Z, i.e., substantially horizontally aligned (see FIGS. 2, 3 and 6).

The top surface 31 has an opening 27, which is circular in the present embodiment, which is designed to receive the third cylinder portion 8c of the output flange 8 (see FIG. 6). Preferentially, the opening 27 is designed in such a way that it positively encloses the third cylinder portion 8c of the output flange 8, i.e., the areas of the top surface 31 surrounding the opening 31 touch the third cylinder portion 8c of the output flange 8. The top surface 31 has fastening elements 27a, for example screws and/or pins and/or magnets, in particular in an area around the opening 27, which are designed to fasten the output flange 8, for example at a bottom side of a protrusion formed by the second cylinder portion 8b (see FIG. 6), to the top surface 31, preferentially detachably.

The bottom surface 32 also has an opening 28, which is circular in the present embodiment, which is designed to be provided around the bearing unit 6 (see FIG. 6). Preferentially, a diameter of the opening 28 is greater than an outer diameter of the bearing unit 6 so that a gap surrounding the bearing unit 6 on all sides is provided between the bearing unit 6 and the bottom surface 32. In other words, the bottom surface 32 is provided so as to be movable to a certain extent relative to the bearing unit 6.

In the present embodiment, the spring elements 23-26 are arranged in pairs opposing each other, wherein the spring elements 23 and 24 form a first opposing pair, and the spring elements 25 and 26 form a second opposing pair. In the present embodiment, the spring elements 23-26 are each designed as a leaf spring, consisting of a straight metal strip 23a, 24a, 25a, 26a designed so as to be substantially elongated, which has respective brackets 23b, 23b′, 24b, 24b′, 25b, 25b′, 26b, 26b′ at either end with respect to the longitudinal extension. The metal strips are each designed so as to be flexible, i.e., they allow deflection transverse to their longitudinal extension. The spring elements 23, 24 of the first opposing pair are each firmly connected to the base plate 9 of the laboratory device 1 via the respective brackets 23b′, 24b′ at one end, represented in FIG. 2 for the spring element 24 by way of example, and firmly connected to the bottom surface 32 of the frame element 7 via the respective brackets 23b, 24b at the other end (see FIG. 5). Thus, the bottom surface 32 is provided so as to be movable in a direction perpendicular to the central axis Z and perpendicular to the longitudinal extension of the spring elements 23, 24 of the first opposing pair. In FIG. 5, the spring elements 25, 26 of the second opposing pair are each firmly connected to the bottom surface 32 of the frame element 7 via the respective brackets 25b′, 26b′ at one end, and firmly connected to the top surface 31 of the frame element 7 via the respective brackets 25b, 26b at the other end. In FIG. 3, this is represented for the spring element 26 by way of example. Thus, the top surface 31 opposing the bottom surface 32 is provided so as to be movable in a second direction perpendicular to the central axis Z and perpendicular to the longitudinal extension of the spring elements 25, 26 of the second opposing pair. Overall, the described configuration of the frame element 7 results in a movability of the top surface 31 enclosing the output flange 8 in a plane perpendicular to the central axis Z, in particular in a horizontal plane. Thereby, the circular or oval oscillating movement (orbital or vibrational movement) mentioned above of the output flange 8 and the carrier plate 2 is enabled in a plane perpendicular to the central axis Z.

During operation of the shaking and/or mixing device 1 of the first embodiment, the drive 3 is put into operation to impart a rotational motion about the central axis Z to the output shaft 5 via the belt 4 and the flange 12. The rotational movement of the output shaft 5 is transmitted eccentrically to the output flange 8 and thus causes the circular or oval oscillating movement (orbital or vibrational movement) mentioned above of the output flange 8 and the carrier plate 2, on which a sample not shown in the Figures is arranged. By fastening the output flange 8 to the frame element 7, the spatial orientation of the output flange 8 and the carrier plate 2 is conserved, i.e., there is no rotation thereof about the center axis M. Due to the substantially horizontal alignment of the top surface 31 of the frame element 7 and the extension of the bores 21, 22 and the fastening element 14 parallel to the central axis Z, the output flange 8, and thus also the carrier plate 2, is arranged so as to be substantially horizontal, or perpendicular to the central axis Z, respectively, so that the carrier plate 2 executes the orbital or vibrational movement in the plane of the carrier plate, i.e., perpendicular to the central axis Z, during operation of the shaking and/or mixing device 1.

A modularity of the shaking and/or mixing device 1 of the first embodiment is already provided by the fact that the output flange 8 with the carrier plate 2 is selectively attachable to one of the two bores 21, 22. Thereby, orbital or vibrational movements with different radii or amplitudes of movement may be achieved.

In the following, a second embodiment of a laboratory device according to the invention will be described with reference to FIGS. 7 to 11. The laboratory device of the second embodiment is also designed as a shaking and/or mixing device 100. Elements of the shaking and/or mixing device 100 of the second embodiment that are identical or similar to elements of the first embodiment are referred to by the same reference numerals in the Figures, and explanations thereof will not be repeated in detail.

In particular, the shaking and/or mixing device 100 of the second embodiment may be provided with the base unit, that is, the base plate 9, the drive 3 and the bearing unit 6, of the shaking and/or mixing device of the first embodiment described above, as well as its carrier plate 2. The output shaft 105, the frame element 107 and the output flange 108 according to the second embodiment differ from the respective elements of the first embodiment.

The output shaft 105 according to the second embodiment will be described in more detail in the following with reference to FIGS. 9a and 9b. Similar to the output shaft of the first embodiment, the output shaft 105 of the second embodiment extends along its central axis Z from an upper end 5a to a lower end 5b and has the portions 15, 16, 17 and 18 described above. In contrast to the output shaft of the first embodiment, the output shaft 105 has an additional end portion 115 at its upper end 5a. The end portion 115 has a surface 115a at the upper end 5a, which makes an angle a distinct from 90° with the central axis Z. For example, the angle a may be 85°. The surface 115a at the upper end 5a of the end portion 115 preferentially serves as a contact surface on which the output flange 8 rests and/or to which it is fastenable.

The output shaft 105 of the second embodiment has a bore 121 extending from the upper end 5a towards the lower end 5b of the output shaft 105 and is designed to receive the fastening element 14 for attaching the output flange 108 to the output shaft 105 (see FIG. 9a and FIG. 11). The bore 121 does not extend parallel to the central axis Z but forms an angle β with the central axis Z. In other words, the center axis M of the output flange 108 intersects the central axis Z at a central point E (see FIG. 11), wherein the two axes Z and M make the angle β. Preferentially, the axis of the bore 121 is chosen in such a way that the center axis M of the output flange 108 is perpendicular to the surface 115a of the end portion 115 (contact surface) of the output shaft 105 (see FIG. 9b). That is, for the case of α=85°, preferentially β=5°. The angle a of the surface 115a and/or the angle β of the bore 121 define an attachment position of the carrier plate 2. In other words, the plane of the carrier surface 2a in the present second embodiment is inclined by the angle β relative to the horizontal.

Thereby, a rotational movement of the output shaft 105 about its central axis Z is transmitted to the output flange 108 and to the carrier plate 2 as a wobbling movement, during which the carrier plate 2 executes a rotating tilting movement about the central point E.

The output flange 108 of the second embodiment is designed similarly to the output flange of the first embodiment but has only one first cylinder portion 108a and one second cylinder portion 108b, as shown in FIG. 11. The first cylinder portion 108a has, analogously to the first embodiment, a smaller diameter than the second cylinder portion 108b and is designed to extend through the central recess of the carrier plate 2 so that the carrier plate 2 rests on a protrusion formed by the second cylinder portion 108b and is fastenable thereto. The second cylinder portion 108b may, for example, have a downwardly increasing diameter, as shown in FIG. 11, or have a constant diameter (not shown in the Figures), and is designed to be attached to the frame element 107 so as to be pivotable. For this purpose, in the present embodiment, the second cylinder portion 108b has two bores 109 opposing each other in a circumferential direction, which each extend from an outer surface of the second cylinder portion 108b along a common bore axis F towards the center axis M of the output flange 108. The bores 109 are designed in such a way that the bore axis F intersects the central axis Z of the output shaft 105 and the center axis M of the output flange 108 at the central point E (see FIG. 11). The bores 109 are designed to receive pins 110 of the frame element 107 (see FIG. 10) in such a way that the pins 110 are held in the bores 109 so as to be rotatable about the bore axis F.

In the following, the frame element 107 of the second embodiment will be described with reference to FIG. 10. The frame element 107 has a frame 111 which, in the present embodiment, is designed so as to be substantially round, or square with rounded corners, with a central recess 112, which is designed in such a way that the frame 111 encloses the second cylinder portion 108b of the output flange 108 without being in contact with it when the frame element 107 is attached to the laboratory device (see FIGS. 7, 8, 11). In other words, a circumferential inner surface 111a of the frame 111, which delimits the central recess 112, is provided at a distance from the output flange 108 when the frame element 107 is attached to the laboratory device.

The frame element 107 has the two pins 110 mentioned above, wherein the pins 110 are provided on respective opposing sides of the inner surface 111a and extend along a common axis H from the inner surface 111a into the central recess 112. The pins are designed to be received in the bores 109 of the output flange 108 when the frame element 107 is attached to the laboratory device (see FIG. 11). When the frame element 107 is attached to the laboratory device, the axis H of the pins 110 thus corresponds to the bore axis F of the bores 109 of the output flange 108.

On an outer side 111b of the frame 111 facing away from the central recess 112, brackets 113 are provided on respective opposing sides of the frame 111. The brackets 113 are fastenable to the base plate 9 (see FIGS. 7, 8). The brackets 113 are connected to the frame 111 so as to be pivotable so that the frame 111 is tiltable relative to the brackets 113 about an axis G, wherein the axis G is perpendicular to the axis H of the pins 110. The axis G of the brackets 113 is preferentially perpendicular to the central axis Z when the frame element 107 is attached to the laboratory device. Preferentially, the axis H of the pins 110 and the axis G of the brackets 113 intersect at a common point and are perpendicular to each other. In other words, the brackets are preferentially offset by 90° from the pins 110 in the circumferential direction of the frame 107.

The pivotable mounting of the frame 111 with respect to the brackets 113 allows a rocking movement of the frame about the axis G, during which the frame 111 is tilted alternately in opposite directions about the axis G. The frame element 107 of the present second embodiment is therefore also referred to as a rocking frame.

On a top side 111c of the frame 111, i.e., a side facing away from the base plate 9 when the frame element 107 is attached to the base plate 9, fastening elements are provided in the form of spacer bolts 114. In the present embodiment, the frame element 107 comprises four spacer bolts 114, which are provided at regular intervals and each at locations between the pins 110 and the brackets 113 on the top side 111c. The spacer bolts 114 each extend upwards from the top side 111c, i.e., away from the base plate 9 when the frame element 107 is attached to the base plate 9. The spacer bolts 114 are designed to fasten the carrier plate 2 to the frame element 107. The spacer bolts 114 are dimensioned in such a way that they extend upwards along the central axis Z beyond the first cylinder portion 108a of the output flange 108 when the spacer bolts 114 are attached to the frame element 107 (see FIG. 12). Attaching the carrier plate 2 to the spacer bolts thus defines an alternative attachment position of the carrier plate 2 to the laboratory device (see FIG. 12). The spacer bolts are detachably connected to the frame 111. In the embodiment described presently, in which a wobbling movement is imparted to the carrier plate 2, the spacer bolts 114 are not used (see FIG. 11, where the spacer bolts are not attached to the frame element 107 and the carrier plate 2 is fastened to the output flange 108).

During operation of the shaking and/or mixing device 100 of the second embodiment, the drive 3 is put into operation to impart a rotational motion about the central axis Z to the output shaft 105 via the belt 4 and the flange 12. The rotational movement of the output shaft 105 causes the rotating tilting movement mentioned above of the output flange 108 and the carrier plate 2, on which a sample not shown in the Figures is arranged, about the central point E (wobbling movement). In other words, the center axis M of the output flange 108 rotates about the central axis Z during this movement. Due to the fastening of the output flange 108 to the frame element 107 by means of the pins 110, there is no rotation of the output flange 108 about the center axis M. Simultaneously, due to the rotatable mounting of the pins 110 in the bores 109 about the bore axis F and the pivotability of the frame 111 about the axis G, the wobbling movement of the output flange 108 is not hindered. A rocking movement about the axis G is imparted to the frame 111.

According to a modification shown in FIG. 12 of the shaking and/or mixing device 100 of the second embodiment, the carrier plate 2 is not attached to the output flange 108 as a first attachment position but to the spacer bolts 114 as a second attachment position. The carrier plate 2 therefore does not follow the wobbling movement of the output flange 108 but the rocking movement of the frame about the axis G. In FIG. 12, the axis G is perpendicular to the page through the point E.

A modularity of the shaking and/or mixing device 100 of the second embodiment is already provided by the fact that the carrier plate 2 is optionally attachable to the output flange 108 (first attachment position) or by means of the spacer bolts 114 to the frame element 107 (second attachment position). Thereby, the user may choose whether a wobbling or rocking movement should be imparted to the carrier plate 2 during operation of the laboratory device.

In the following, a third embodiment of a laboratory device according to the invention will be described with reference to FIGS. 13 to 17. The laboratory device of the third embodiment is also designed as a shaking and/or mixing device 200. Elements of the shaking and/or mixing device 200 of the third embodiment that are identical or similar to elements of the first and/or second embodiments are referred to by the same reference numerals in the Figures, and explanations thereof will not be repeated in detail.

In particular, the shaking and/or mixing device 200 of the third embodiment may be provided with the base unit, that is, the base plate 9, the drive 3 and the bearing unit 6, of the shaking and/or mixing device of the first and/or second embodiments described above, as well as its carrier plate 2 (see FIG. 15 in particular). The output shaft 205 and the frame element 207 according to the third embodiment differ from the respective elements of the first and/or second embodiments. In particular, the shaking and/or mixing device 200 of the third embodiment may be provided without an output flange as described above with respect to the first and/or second embodiments.

The output shaft 205 according to the third embodiment will be described in more detail in the following with reference to FIGS. 16a, 16b and 16c. Similar to the output shaft of the first and/or second embodiments, the output shaft 205 of the third embodiment extends along its central axis Z from an upper end 5a to a lower end 5b and has the portions 15, 16, 17 and 18 described above. In contrast to the output shaft of the first and/or second embodiments, the output shaft 205 has an additional transfer portion 215 at its upper end 5a. In the present embodiment, the transfer portion 215 is designed so as to be cylindrical and defines a center axis M′ which is provided so as to be parallel to the central axis Z and offset therefrom by a distance d′.

Optionally, the transfer portion 215 may have a bore 221 for attaching the carrier plate 2 and/or an output flange, which bore may define a further attachment position of the carrier plate 2, in particular if the shaking and/or mixing device 200 is used without the frame element 207 (not shown in the Figures). The optional bore 221 may, for example, be designed similarly to the bore 21, 22 described above with reference to the first embodiment, i.e., for example, may extend along the center axis M′ and a center point C′ of the bore 221 may lie on the center axis M′ (see FIG. 16c) so that the center axis M′ and/or a center axis of an output flange (not shown in the Figures) attached to the output shaft is provided so as to be offset from the central axis Z by the distance d′ (see FIG. 16c). An exposed surface of the transfer portion 215 may be designed so as to be perpendicular to the center axis M′ and serve as a contact surface on which an output flange (not shown) rests and/or to which it is fastenable (see the explanations thereof with respect to the first embodiment).

Due to the spacing of the center axis M′ of the transfer portion 215 from the central axis Z, a rotational movement of the output shaft 5 about the central axis Z causes an eccentric movement of the transfer portion 215.

In the following, the frame element 207 of the third embodiment will be described with reference to FIG. 17. The frame element 207 is substantially designed as a carriage displaceable along guide elements. In detail, the carriage is formed by a plate 211, in the present case a rectangular plate, which is provided so as to be movable by means of sleeves 210 along guide elements in the form of two bars 208, 209 extending parallel to one another with respective longitudinal axes K1, K2 so that the plate 211 is provided so as to be displaceable along the direction of the longitudinal axes K1, K2. The rods 208, 209 are attachable to the base plate 9 of the shaking and/or mixing device 200 at their ends by means of respective brackets 213 (see FIGS. 13-15). The brackets 213 are preferentially provided on a side of the rods 208, 209 opposite the plate 211 and/or extend away from the rods parallel to the central axis Z when the frame element 207 is attached to the laboratory device. Preferentially, the direction of the longitudinal axes K1, K2 of the rods 208, 209 is perpendicular to the central axis Z when the frame element 207 is attached to the base plate 9.

The plate 211 has a recess 212 designed so as to be elongated, the longitudinal axis L of which extends perpendicularly to the direction of the longitudinal axes K1, K2 of the rods 208, 209. The recess 212 is designed to receive the transfer portion 215 of the output shaft 205 (see FIGS. 16a, 16b) and allows a movement of the transfer portion 215 in the recess 212 along its longitudinal axis L, as well as a rotation of the transfer portion 215 about its center axis M′.

On a top side 211a of the plate 211, i.e., a side facing away from the base plate 9 when the frame element 207 is attached to the base plate 9 (see FIGS. 13-15), fastening elements are provided in the form of spacer bolts 214. In the present embodiment, the frame element 207 comprises four spacer bolts 214, each extending upwards from the top side 211a of the plate 211, i.e., away from the base plate 9 when the frame element 207 is attached to the base plate 9. The spacer bolts 214 are designed to fasten the carrier plate 2 to the frame element 207 and are dimensioned in such a way that they extend upwards along the central axis Z beyond the transfer portion 215 of the output shaft 205 (see FIGS. 13-15). The spacer bolts 214 may, for example, be detachably connected to the plate 211. Preferentially, the plane of the carrier surface 2a of the carrier plate 2 is provided so as to be perpendicular to the center axis M′ and to the central axis Z when the carrier plate 2 is attached to the frame element 207 by means of the spacer bolts 114.

This configuration of the frame element 207 causes the eccentric movement of the transfer portion 215 of the output shaft 205 to be transmitted to an oscillating or reciprocal movement of the plate 211 along the direction of the longitudinal axes K1, K2 of the rods 208, 209 during movement of the output shaft about the central axis Z. This movement of the plate 211 along the direction of the longitudinal axes K1, K2 is enabled in particular by the fact that the transfer portion 215 of the output shaft 205 can move exclusively along the longitudinal axis L of the recess 212 of the plate 211 and the plate 211 is displaceable exclusively along the direction of the longitudinal axes K1, K2 of the rods 208, 209. The frame element 207 of the present third embodiment is therefore also referred to as a reciprocal frame. Furthermore, by rotating the transfer portion 215 about its center axis M′ in the recess 212, as well as guiding the plate 211 along the rods 208, 209, rotation of the plate 211 and thus of the carrier plate 2 about the center axis M′ or the central axis Z may be prevented.

FIGS. 13 to 15 show views of the shaking and/or mixing device 200 with the frame element 207 and the carrier plate 2 attached. As may be discerned in particular in FIG. 13, through a central recess of the carrier plate 2, a portion of the plate 211 of the frame element 207 with the recess 212 is visible, through which the transfer portion 215 of the output shaft 205 extends (see also FIG. 15). During operation of the shaking and/or mixing device 200 of the third embodiment, the drive 3 is put into operation to impart a rotational motion about the central axis Z to the output shaft 205 via the belt 4 and the flange 12 (not shown in FIGS. 13-15). This rotational movement of the output shaft 205 causes a movement of the carrier plate 2 and a sample arranged thereon, not shown in the Figures, to an oscillating movement exclusively in the direction of the longitudinal axes K1, K2 of the rods 208, 209.

A modularity of the shaking and/or mixing device 200 of the third embodiment may be provided, for example, by the fact that the carrier plate 2 is optionally attached to the plate 211 of the frame element 207 via the spacer bolts 214 (first attachment position), or is optionally attachable to the bore 221 of the transfer portion 215 and/or of an output flange (not shown) (second attachment position).

The modularity of a laboratory device, in particular a shaking and/or mixing device, may be further increased by combining elements of the first, second and/or third embodiments with each other. Hence, for example, a modular laboratory device may be provided with a base unit described above and a carrier plate described above, as well as the respective output shafts, output flanges and/or frame elements of the first and/or second and/or third embodiments. A user may then decide, for example, whether the laboratory device is operated with the respective output shaft, the frame element and optionally the output flange of the first, second or third embodiments. Further, as described above, at least in the first and second (optionally also the third) embodiments, the user has the choice between two distinct attachment positions of the carrier plate. Thereby, different types of movement may be realized to thoroughly mix a sample.

The embodiments of the shaking and/or mixing device described above are to be understood as non-limiting examples. The individual components may also be realized differently and may in particular deviate from the configuration described above regarding their form.

In the first embodiment of the laboratory device described above, instead of the frame element designed as a leaf spring frame, any other frame element may also be used, which is designed to receive the output flange in such a way that rotation of the output flange about its center axis is prevented, however, to simultaneously allow the desired movement (vibrational or orbital movement) in a plane perpendicular to the central or center axes. Correspondingly, the frame element of the second and third embodiments is not limited to the described configuration either.

In the shaking and/or mixing device described above, the sample receiving element is designed as a plate. However, within the scope of the present application, sample receiving elements designed so as to be other than plate-shaped are also possible, for example a bracket in which the sample is held in a standing and/or suspended fashion.

The present invention is not limited to shaking and/or mixing devices but may also be applied to other laboratory devices. For example, the invention is also applicable to a magnetic stirrer, which is designed to thoroughly mix a sample by means of a magnetically driven stirring rod arranged in the sample itself, as the laboratory device. This makes it possible, for example, to thoroughly mix a sample by means of the movement sequences achievable by the laboratory device according to the invention additionally or alternatively to thorough mixing of the sample by means of the stirring rod.

1. A modular laboratory device, in particular a shaking and/or mixing device (1, 100, 200), comprising:
a sample receiving element (2), which is designed to receive a sample,
a drive (3), and
at least one transfer element (5, 7, 8, 105, 107, 108, 205, 207), which has a central axis (Z) and is designed to be driven by the drive (3) to perform a rotational movement about the central axis (Z) and to transmit this rotational movement to the sample receiving element (2) in such a way that it executes a defined movement sequence,
wherein the laboratory device comprises at least one first transfer element and one second transfer element, wherein the first and the second transfer elements are selectively and replaceably insertable into the laboratory device (1, 100, 200), and the first transfer element is designed to transmit the rotational movement to the sample receiving element (2) in such a way that the sample receiving element executes a first movement sequence, and the second transfer element is designed to transmit the rotational movement to the sample receiving element (2) in such a way that the sample receiving element executes a second movement sequence, which differs from the first movement sequence, and/or
wherein the laboratory device comprises at least one third transfer element, which is designed in such a way that the sample receiving element (2) is attachable to the third transfer element at a first attachment position and at a second attachment position distinct from the first attachment position, and to transmit the rotational movement to the sample receiving element (2) at the first attachment position in such a way that the sample receiving element executes a third movement sequence, and to transmit it to the sample receiving element (2) at the second attachment position in such a way that the sample receiving element executes a fourth movement sequence, which differs from the third movement sequence.

2. The modular laboratory device of claim 1, wherein the first and second movement sequences and/or the third and fourth movement sequences are each from the following group of movement sequences:
a movement exclusively in a plane perpendicular to the central axis (Z),
a movement having exclusively movement components parallel to the central axis (Z),
a movement having both movement components parallel to the central axis (Z) and movement components perpendicular to the central axis (Z),
and are preferentially each one of the following group of movement sequences:
an oscillating movement in exclusively one direction (K1, K2) perpendicular to the central axis (Z),
a circular or oval oscillating movement in a plane perpendicular to the central axis (Z) with a first radius or a second radius distinct from the first radius,
a rocking movement, during which the sample receiving element is tilted alternately in opposite directions about an axis (G), preferentially an axis perpendicular to the central axis (Z),
a wobbling movement, during which the sample receiving element executes a rotating tilting movement about a central point (E), preferentially a central point on the central axis (Z).

3. The modular laboratory device of claim 1, wherein the first and the second transfer elements differ in an attachment position of the sample receiving element (2) to the respective transfer element.

4. The modular laboratory device of claim 1, further comprising a fastening element (8, 13, 14, 21, 22, 108, 121, 221), which is designed to attach the sample receiving element (2) to the respective transfer element at the respective attachment position, wherein the fastening element has a center axis (M), which defines the attachment position, and wherein the respective attachment position is defined by one of the following features:
the center axis (M) of the fastening element is parallel to the central axis (Z) and offset therefrom, in particular by a first distance (d1) or a second distance (d2) not equal to the first distance;
the center axis (M) of the fastening element intersects the central axis (Z) at an angle greater than 0° and less than 90°, preferentially at an angle between 2° and 10°, in particular 5°.

5. The modular laboratory device of claim 4, wherein the respective transfer element is designed to maintain a spatial orientation of the sample receiving element (2) with respect to the center axis (M) of the fastening element, in particular to prevent rotation of the sample receiving element about the center axis (M) of the fastening element.

6. The modular laboratory device of claim 4, wherein a plane of the sample receiving element (2), in particular a plane of a carrier surface (2a) of the sample receiving element, is provided so as to be perpendicular to the center axis (M) of the fastening element.

7. The modular laboratory device of claim 4, wherein the respective transfer element comprises an output shaft (5, 105), which extends across the central axis (Z) from an upper end (5a) to a lower end (5b) and which is designed to be driven by the drive (3) to perform a rotational movement about the central axis (Z),
wherein the fastening element comprises a bore (21, 22, 121) provided in the output shaft (5, 105), which extends from the upper end (5a) towards the center axis (M), and/or
wherein the output shaft (5, 105) comprises a contact surface (115a) at the upper end (5a) for attaching the sample receiving element, and the contact surface (115a) extends perpendicularly to the center axis (M) of the fastening element.

8. The modular laboratory device of claim 4, wherein the respective transfer element comprises a frame element (7, 107), which is designed to prevent rotation of the sample receiving element about the center axis (M).

9. The modular laboratory device of claim 8, wherein the frame element (7) comprises at least one elastic element, in particular a spring element (23, 24, 25, 26), preferentially a leaf spring, and is designed to allow a movement of the sample receiving element (2) in a plane perpendicular to the central axis (Z), in particular a circular or oval oscillating movement in a plane perpendicular to the central axis (Z), and preferentially allows a movement exclusively in this plane.

10. The modular laboratory device of claim 8, wherein the frame element (107) comprises a frame (111), which is attached to the laboratory device so as to be pivotable about a first axis (G), and wherein the sample receiving element is attachable to the frame (111) so as to be pivotable about a second axis (H, F), wherein the first axis (G) and the second axis (H, F) intersect the central axis (Z) at a central point (E).

11. The modular laboratory device of claim 10, wherein the center axis (M) of the fastening element intersects the central axis (Z) at an angle greater than 0° and less than 90°, and the intersection point of the center axis with the central axis is the central point (E).

12. The modular laboratory device of claim 10, wherein the transfer element comprises an output shaft (105), which is designed to be driven by the drive (3) to perform a rotational movement about the central axis (Z), and an output flange (108), which has, along the center axis (M) of the fastening element, which intersects the central axis (Z) at an angle greater than 0° and less than 90°, an upper portion (108a) and a lower portion (108b), wherein the lower portion (108b) is attached to the output shaft (105) and the upper portion (108a) defines a first attachment position of the sample receiving element (2), at which the sample receiving element (2) is attached to the upper portion (108a), and wherein the frame element (107) defines a second attachment position of the sample receiving element (2), at which the sample receiving element (2) is attached to the frame element (107).

13. The modular laboratory device of claim 12, wherein the transfer element is designed in such a way that the sample receiving element (2), during operation of the laboratory device, executes a wobbling movement about the central point (E) if it is at the first attachment position, and executes a rocking movement about the first axis (G) if it is at the second attachment position.

14. The modular laboratory device of claim 1 wherein the transfer element comprises an output shaft (205), which extends along the central axis (Z) from an upper end (5a) to a lower end (5b) and which is designed to be driven by the drive (3) to perform a rotational movement about the central axis (Z), and
wherein the transfer element further comprises a frame element (207), which is designed to transmit the movement of the output shaft (205) about the central axis (Z) to the sample receiving element (2) in such a way that the sample receiving element executes a movement exclusively in a plane perpendicular to the central axis (Z), in particular an oscillating movement in exclusively one direction (K1, K2) perpendicular to the central axis (Z).

15. The modular laboratory device of claim 14, wherein the frame element (207) has a carriage (210, 211) and a guide element (208, 209) extending along a first axis (K1, K2), on which the carriage (210, 211) is provided so as to be displaceable, and wherein the carriage (210, 211) has a recess (212) designed so as to be elongated, whose longitudinal axis (L) extends transversely, preferentially perpendicularly, to the first axis (K1, K2), and
wherein more preferably, the output shaft (205), at its upper end (5a), has a transfer portion (215), which defines a center axis (M′), which is provided so as to be parallel to the central axis (Z) and offset therefrom by a distance (d′), and the recess (212) of the carriage is designed to receive the transfer portion (215) so that the transfer portion (215) is provided in the recess (212) so as to be movable along its longitudinal axis (L), and/or
wherein preferentially, the sample receiving element (2) is attachable to the carriage.

16. The modular laboratory device of claim 1, comprising a base plate (9), on which the drive (3) is arranged, and a bearing unit (6), which is attached to the base plate (9) and which is designed in such a way that the respective transfer element is insertable into the bearing unit (6) in such a way that the transfer element is held in the bearing unit (6) so as to be rotatable about the central axis (Z) and the central axis (Z) is preferentially arranged vertically and/or perpendicularly to a plane of the base plate (9), and the respective transfer element is removable from the bearing unit (6),
wherein preferentially, the base plate (9), the drive (3) and the bearing unit (6) form a base unit to which the respective transfer element is selectively attachable, and/or
wherein preferentially, the drive (3) is provided so as to be offset from the central axis (Z) and connected to the bearing unit (6) via a belt (4).

17. The modular laboratory device of claim 1, wherein the sample receiving element is designed as a carrier plate.

18. A laboratory device, in particular a shaking and/or mixing device (100), comprising:
a sample receiving element (2) for receiving a sample,
a drive (3), and
a transfer element (5, 7, 8, 105, 107, 108, 205, 207), which has a central axis (Z) and is designed to be driven by the drive (3) to perform a rotational movement about the central axis (Z) and to transmit this rotational movement to the sample receiving element (2) in such a way that it executes a defined movement sequence,
wherein the transfer element comprises:
an output shaft (105), which is designed to be driven by the drive (3) to perform a rotational movement about the central axis (Z),
an output flange (108) with a center axis (M), which intersects the central axis (Z) at a central point (E) at an angle greater than 0° and less than 90°, and
a frame element (107),
wherein the frame element (107) comprises a frame (111), which is attached to the laboratory device so as to be pivotable about a first axis (G), and the sample receiving element (2) is attachable to the frame (111) so as to be pivotable about a second axis (H),
wherein the first axis (G) and the second axis (H) intersect at the central point (E).

19. The frame element (107) of claim 18, wherein the output flange (108) has, along the center axis (M), an upper portion (108a) and a lower portion (108b), wherein the lower portion (108b) is attached to the output shaft (105) and the upper portion (108a) defines a first attachment position of the sample receiving element (2), at which the sample receiving element (2) is attached to the upper portion (108a),
and the frame element (107) defines a second attachment position of the sample receiving element (2), at which the sample receiving element (2) is attached to the frame element (107).

20. The frame element of claim 18, wherein the frame element (107) is designed to prevent rotation of the sample receiving element about the center axis (M) of the output flange (108), and/or
wherein the laboratory device is designed in such a way that the sample receiving element (2), during operation of the laboratory device, executes a wobbling movement about the central point (E) if it is at the first attachment position, and/or
wherein the frame element is designed in such a way that the sample receiving element (2), during operation of the laboratory device, executes a rocking movement about the first axis (G) if it is at the second attachment position.

21. A method for using a modular laboratory device of claim 1, comprising selecting a transfer element from at least the first transfer element and the second transfer element and inserting the selected transfer element into the laboratory device, and/or comprising selecting the attachment position of the sample receiving element from at least the first attachment position and the second attachment position on the third transfer element and attaching the sample receiving element at the selected attachment position.
